(19) United States
(12) Patent Application Publication
(10) Pub. No.: US 2002/0051083 A1
(43) Pub. Date: May 2, 2002

(54) Display apparatus

(76) Inventors: Shuntaro Aratani, Tokyo (JP); Katsuhiro Miyamoto, Kanagawa (JP); Yuichi Matsumoto, Kanagawa (JP); Hideaki Yui, Kanagawa (JP)

Correspondence Address: FITZPATRICK CELLA HARPER & SCINTO, 30 ROCKEFELLER PLAZA, NEW YORK, NY, 10112, US

(21) Appl. No.: 09/852,612

(22) Filed: May 11, 2001

(30) Foreign Application Priority Data
May 12, 2000 (JP) 140378/2000

(51) Int. Cl. H04N 7/00; H04N 11/00

(52) U.S. Cl. 348/554

(57) ABSTRACT

A TV monitor has a TV mode and a PC mode and is connected to a computer via a home network. When a user chooses the TV mode, the TV monitor operates independently of the computer, so that an input/output device of the TV monitor operates as that of the TV monitor. If the user chooses the PC mode, on the other hand, the TV monitor operates as a monitor of the computer, so that the input/output device of the TV monitor operates as that of the computer.

### BACKGROUND OF THE INVENTION

1. Field of the Invention

The present invention relates to a display apparatus for operating as a monitor which displays a TV signal or for operating as a computer monitor.

2. Related Background Art

In recent years, a TV monitor has been going intelligent rapidly. For example, a TV monitor (so-called “Internet TV”) has recently been developed which is provided with a browser for browsing a Web page on the WWW (World Wide Web). Furthermore, with a recent tendency of TV monitors going more and more intelligent, a variety of types of input/output devices can be connected to them.

However, the conventional TV monitor suffers from a problem that it cannot operate a computer by the use of its own input/output device, though it can display image signals fed from the computer. Accordingly, the TV monitor cannot operate a computer by the use of its own input/output device, even when it is connected to the computer via a home network.

### SUMMARY OF THE INVENTION

It is an object of the present invention to permit an input/output device of a TV monitor to operate as that of a computer to thereby operate the computer by the use of the TV monitor input/output device.

According to one suitable aspect for the accomplishment of such an object, there is provided a display apparatus, comprising:

display means;

connecting means for connecting the display apparatus and an external apparatus; and

control means for controlling the display means so as to operate as a monitor of the external apparatus when a first mode is chosen, and controlling the display means so as to operate as a monitor of the external apparatus when a second mode is chosen.

Still other objects of the present invention, and the advantages thereof, will become fully apparent from the following detailed description of the embodiments.

### BRIEF DESCRIPTION OF THE DRAWINGS

FIG. 1 shows a main configuration of a display system in an embodiment according to the present invention;

FIG. 2 shows software components which operate on a CPU121 of a TV monitor 120;

FIG. 3 is an illustrative view of a procedure for permitting the TV monitor 120 and its input/output device to be recognized as an input/output device of a computer 101;

FIG. 4 shows one example of an operation key set of a remote controller 144;

FIG. 5 shows one example of an operation key set of a switch 155; and

FIG. 6 is an illustrative view of a virtual USB hub constituted by a PC mode driver 520.

### DESCRIPTION OF THE PREFERRED EMBODIMENTS

The preferred embodiments of the present invention will now be described in detail hereinafter with reference to the accompanying drawings.

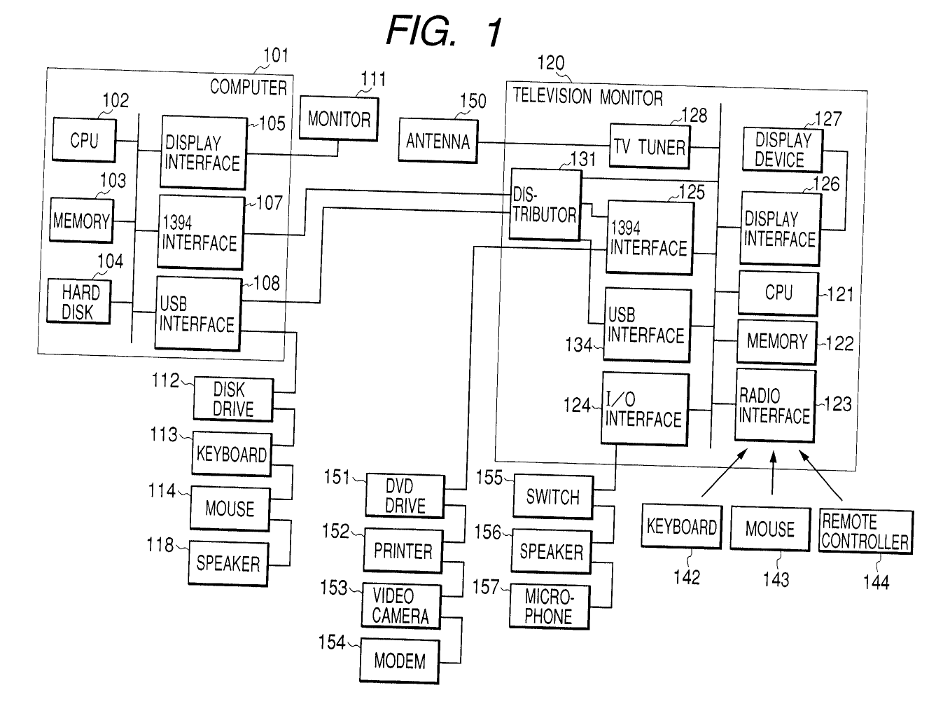

FIG. 1 is a block diagram for showing a main configuration of a display system according to the present embodiment.

In FIG. 1, a reference numeral 101 indicates an information processing apparatus (hereinafter called computer) and a reference numeral 120, a display apparatus (hereinafter called TV monitor) according to the present embodiment.

First the main components of the computer 101 are described with reference to FIG. 1.

A reference numeral 102 indicates a central processing unit (hereinafter called CPU) for controlling the operations of the computer 101. A reference numeral 103 indicates a memory for storing data used temporarily by the CPU102. A reference numeral 104 indicates a hard disk unit for storing programs and data executed or used by the CPU102. A reference numeral 105 indicates a display interface equipped with a video memory. The display interface 105 conducts control so that image data generated by the CPU102 may be displayed on a monitor 111.

A reference numeral 107 indicates a serial communication interface (hereinafter called 1394 interface) in accordance with the IEEE1394-1995 Standards or their extended standards. The 1394 interface 107 communicates with the TV monitor 120 via a home network.

A reference numeral 108 indicates a serial communication interface (hereinafter called USB interface) in accordance with the USB (Universal Serial Bus) Standards or their extended standards. The USB interface 108 communicates with a disk drive 112, a keyboard 113, a mouse 114, and a speaker 118, which are input/output devices of the computer 101.

Next, the main components of the TV monitor 120 are described with reference to FIG. 1.

A reference numeral 121 indicates a central processing unit (hereinafter called CPU) for controlling the operations of the TV monitor 120 as a whole. A reference numeral 122 indicates a memory for storing programs executed by the CPU121 and data temporarily used by it.

The CPU121 controls a TV tuner 128 and also contents displayed on a display device 127 via a display interface 126 according to an event signal input via a radio interface 123 from a keyboard 142, a mouse 143, or a remote controller 144 or according to a state input via an I/O interface 124 from a switch 155.

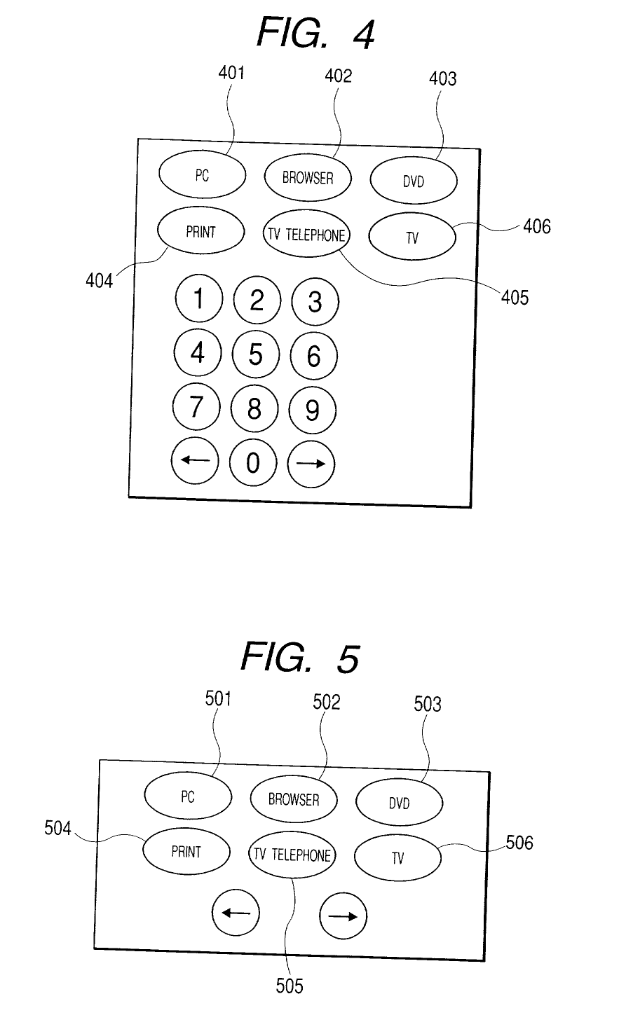

FIG. 4 is an illustration for showing one example of a key configuration of the remote controller. FIG. 5, on the other hand, is an illustration for showing one example of a key configuration of the switch 155. For example, if a user presses a channel selecting key (key having a number thereon) on the remote controller 144, the corresponding information is transferred via the radio interface 123 to the CPU121. The CPU121 in turn controls the TV tuner 128 based on thus transferred information, to switch the selection channel.

A reference numeral 123 indicates a radio interface 123 (hereinafter called radio interface 123) in accordance with the IrDA (Infrared Data Association) Standards. The radio interface 123 communicates with the keyboard 142, the mouse 143, and the remote controller 144, which are input/output devices of the TV monitor 120. A reference numeral 124 indicates an I/O interface. The I/O interface 124 communicates with the switch 155, a speaker 156, and a microphone, which are input/output devices of the TV monitor 120.

A reference numeral 126 indicates a display interface equipped with a video memory. The display interface 126 conducts control so that image data output from the TV tuner 128 or the 1394 interface 125 may be displayed on the display device 127. Also, the display interface 126 conducts control so that image data (which represents time, channel numbers, etc.) generated by the CPU121 may be displayed on the display device 127.

A reference numeral 125 indicates a serial communication interface (hereinafter called 1394 interface) in accordance with the IEEE1394-1995 Standards or their extended standards. The 1394 interface 125 communicates with the computer via a home network. A reference numeral 134 indicates a serial communication interface (hereinafter called USB interface) in accordance with the USB Standards or their extended standards.

A reference numeral 131 indicates a distributor. When the TV monitor 120 enters a TV mode, the distributor 131 is turned OFF to disconnect the 1394 interface 125 and a 1494 interface 117 from each other and also the USB interface 134 and a 1394 interface 108 from each other. Then, the TV monitor 120 operates independently of the computer 101, to thereby permit the input/output devices of the TV monitor 120 to operate as those of its own. If the TV monitor 120 enters a PC mode, on the other hand, the distributor is turned ON to thereby connect the 1394 interface 125 and the 1394 interface 117 with each other and also the USB interface 134 and the 1394 interface 108 with each other. Then, the computer 101 is enabled by a plug-and-play function of the 1394 interface 107 to automatically recognize the TV monitor 120, a DVD driver 151, a printer 152, a video camera 153, and a MODEM 154 as an input/output device of the computer 101. Also, a plug-and-play function of the USB interface 108 enables the computer 101 to automatically recognize the TV monitor as a USB hub and also to automatically recognize the display device 127 of the TV monitor 120 and its input/output devices keyboard 142, mouse 143, speaker 156, and microphone 157 as input/output devices of the computer 101.

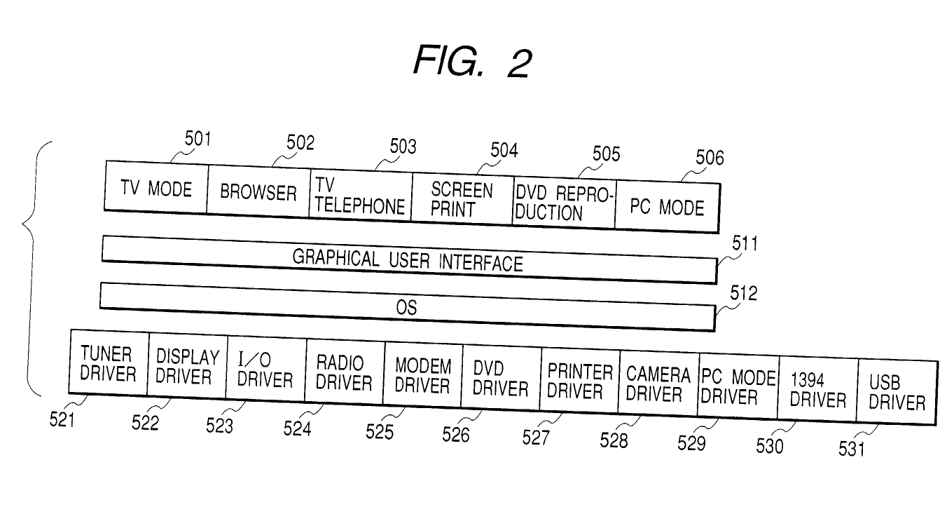

FIG. 2 is an illustration for showing software components which operate on the CPU121 of the TV monitor 120. In FIG. 2, reference numerals 501 to 506 indicate application programs, 511 indicates a graphical user interface (hereinafter abbreviated as GUI), 512 indicates the Operating System (OS), and 521 to 530 indicate driver programs.

The GUI511 is a program for interfacing between the user and the TV monitor 120, specifically controlling the entire screen according to the user's directions by changing the display contents or adjusting, e.g. the sizes and the overlaps of images displayed on the display device 127. The control data output from the remote controller 144 is communicated to the GUI511 via the radio interface 123 and the radio driver 524. Based on thus obtained control data, the GUI511 changes the contents to be displayed on the display device 127 and notifies the other applications of the occurrence of an event corresponding to that control data. The control data output from the switch 155, on the other hand, is communicated to the GUI511 via the I/O interface 124 and the I/O driver 523. Based on thus obtained control data, the GUI511 changes the contents to be displayed on the display device 127 and notifies other applications of the occurrence of an event corresponding to that control data.

The 1394 bus driver 530 supplies data including the control data from the MODEM driver 525, the disk driver 526, the printer driver 527, the camera driver 528, and the PC mode driver 529 to the 1394 interface 125 and also supplies a predetermined driver with 1394 packets and data including the control data received by the 1394 interface 125.

The TV mode application 501 controls the TV tuner 128 so that a user-specified TV channel may be tuned. This TV mode application 501 is made active when a TV key 406 of the remote controller 144 or a TV key 506 of the switch 155 is pressed.

The browser application 502 obtains a Web page specified over the WWW and display it on the display device 127. This browser application 502 is made active when a browser key 402 of the remote controller 144 or a browser key 502 of the switch 155 is pressed.

The TV telephone application 503 controls a TV telephone. This TV telephone application 503 is made active when a TV telephone key 405 of the remote controller 144 or a TV telephone key 505 of the switch 155 is pressed.

The screen print application 504 prints image information displayed on the display device 127. This screen print application 504 is made active when a print key 404 of the remote controller 144 or a print key 504 of the switch 155 is pressed.

The DVD reproduction application 505 controls the operations of the DVD drive 151 connected to a home network. This DVD reproduction application 505 is made active when a DVD key 403 of the remote controller 144 or a DVD key 503 of the switch 155 is pressed.

The PC mode application 506 conducts control so that the TV monitor 120 and its input/output devices (keyboard 142, mouse 143, speaker 156, and microphone 157 in this embodiment) may operate as an input/output device of the computer 101. This PC mode application 506 is made active when a PC key 401 of the remote controller 144 or a PC key 501 of the switch 155 is pressed.

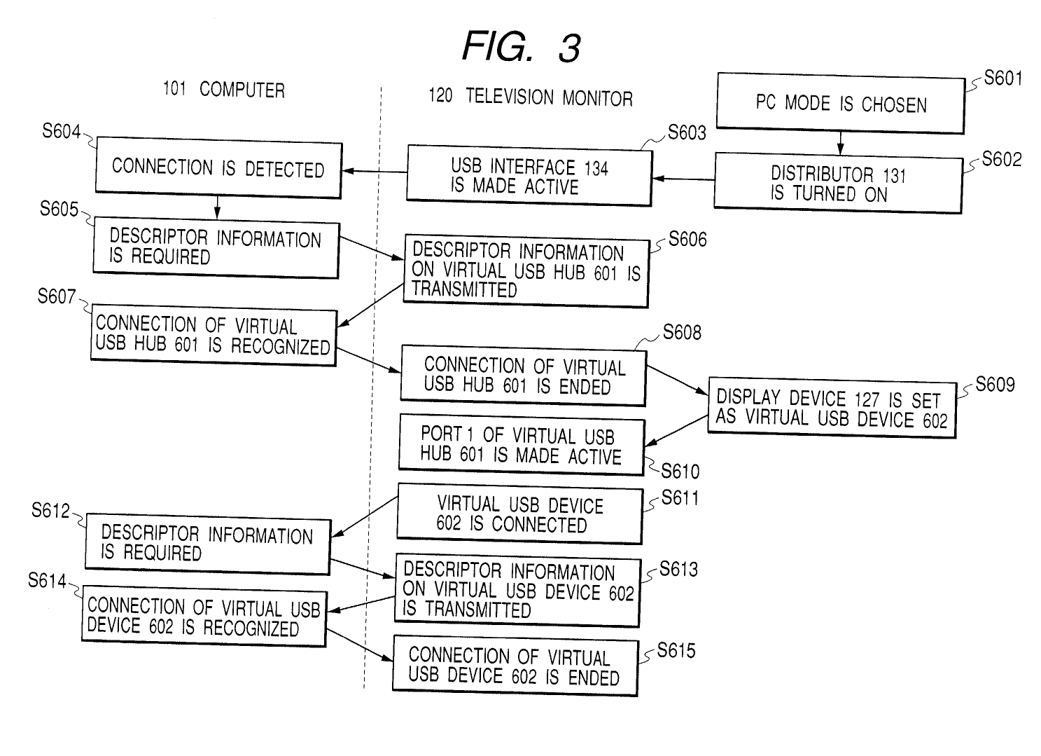

FIG. 3 is an illustration for showing a procedure for permitting the TV monitor 120 and its input/output device to be recognized as an input/output device of the computer 101. In FIG. 3, a procedure is particularly detailed for permitting the computer 101 to automatically recognize as its own monitor the display device 127 of the TV monitor 120.

In FIG. 3, when the user chooses the PC key of the remote controller 144 or the switch 155, the TV monitor 120 enters the PC mode, wherein the CPU121 makes the PC mode application 506 active (S601). Then, the distributor 131 is turned ON (S602) to connect the 1394 interface 125 and the 1394 interface 117 with each other and the USB interface 134 and the 1394 interface 108 with each other (S603).

The USB interface 108 of the computer 101, on the other hand, automatically detects its connection with the USB interface 134 of the TV monitor 120 (S604). Upon detecting of the automatic connection of the USB interface 134, the computer 101 transmits from the USB interface 108 to the TV monitor 120 the control data requiring descriptor information (which describes a type and a function of USB devices), in order to recognize the type and the function of a USB device connected to the USB interface 108 (S605). The PC mode driver 529 transmits from the USB interface 134 to the computer 101 descriptor information on a USB hub virtually built by the PC mode driver 529 (S606). Now, the USB interface 108 of the computer 101 is connected with the USB hub virtually.

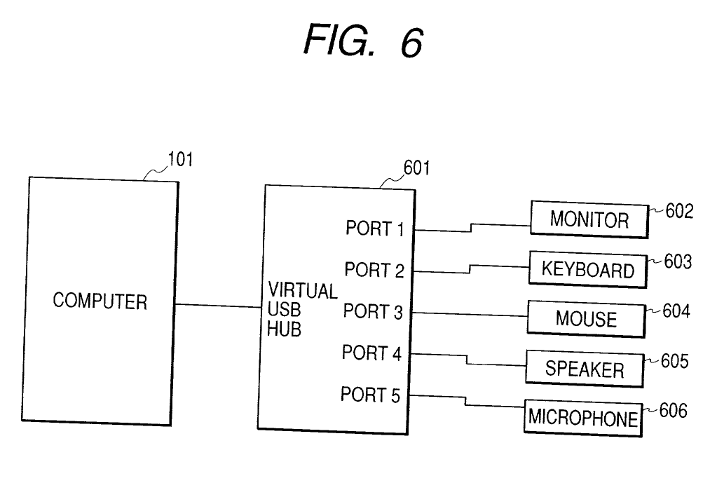

One example is shown in FIG. 6, of a USB hub (hereinafter called virtual USB hub) virtually built by the PC mode driver 529. As shown in FIG. 6, a virtual USB hub 601 has five ports. Those five ports are connected with five virtual USB devices in a one-to-one relationship. A virtual USB device 602 corresponds to the display device 127 of the TV monitor 120. A virtual USB device 603 corresponds to the keyboard 142, which is one of the input/output devices of the TV monitor 120. A virtual USB device 604 corresponds to the mouse 143, which is one of the input/output devices of the TV monitor 120. A virtual USB device 605 corresponds to the speaker 156, which is one of the input/output devices of the TV monitor 120. Finally, a virtual USB device 606 corresponds to the microphone 157, which is one of the input/output devices of the TV monitor 120.

The computer 101 transmits from the USB interface 108 to the TV monitor 120 control data indicating that it has recognized connection of the virtual USB hub 601 (S607). The PC mode driver 529 notifies the PC mode application 506 that the computer 101 has recognized its connection with the virtual USB hub 601 (S608).

When the computer 101 has recognized the connection of the USB hub, the PC mode application 506 sequentially connects to the virtual USB hub 601 the virtual USB devices 602 to 606 which correspond to the display device 127, the keyboard 142, the mouse 143, the speaker 156, and the microphone 157 respectively.

The following will describe a procedure for connecting the virtual USB device 602 corresponding to the display device 127 to the virtual USB hub 601. The PC mode application 506 prompts the PC mode driver 529 to connect the virtual USB device 602 corresponding to the display device 127 to the virtual USB hub 601 (S609). The PC mode driver 529 in turn makes a port 1 of the virtual USB hub 601 active (S601) to then notify the computer 101 that the virtual USB device 602 has been connected to the port 1 (S611). Upon recognizing the connection of the virtual USB device 602 to the port 1 of the virtual USB hub 601, the computer 101 transmits from the USB interface 108 to the TV monitor 120 control data requiring descriptor information on the virtual USB device 602 connected to the port 1 (S612). The PC mode driver 529 asks the PC mode application 506 for the descriptor information on the virtual USB device 602 (i.e., display device 127) connected to the port 1 of the virtual USB hub 601 (S613).

The PC mode application 506 posts the descriptor information on the display device 127 to the PC mode driver 529 (S614). The PC mode driver 529 in turn transmits the descriptor information on the display device 127 from the USB interface 134 to the computer 101 (S615). Upon recognizing the display device 127 as its monitor, the computer 101 transmits image data generated at the CPU102 from the USB interface 108 to the TV monitor 120. The TV monitor 120 supplies the display interface 126 with the image data generated at the CPU102 to thereby cause the display device 127 to display that data thereon. By such a configuration, the TV monitor 120 can permit the display device 127 of the TV monitor 120 to operate as a monitor of the computer 101.

The computer 101 uses almost the same procedure as that for the display device 127, to connect the keyboard 142, the mouse 143, the speaker 144, and the microphone 145 to the virtual USB hub 601. As a result, the computer 101 permits the display device 127, the keyboard 142, the mouse 143, the speaker 144, and the microphone 145 to be recognized as a new input/output device of the computer 101. The computer 101 itself recognizes the display device 127 as a monitor class device, the keyboard 143 and the mouse 143 as a human interface class device, and the speaker 144 and the microphone 145 as a stream class device.

A case where the user operates, for example, the mouse 143 is described as follows. In this case, the PC mode application 506 obtains from the radio driver 524 the data indicating a move of the mouse 143 and posts it to the PC mode driver 529. The PC mode driver 529 in turn transmits the data indicative of the move of the mouse 143 from the USB interface 134 to the computer 101.

As described above, according to the display system of this embodiment, when the user chooses the TV mode, the TV monitor 120 can operate as a TV monitor for displaying a TV signal. If the user chooses the PC mode, on the other hand, the TV monitor 120 operates as a monitor of the computer 101, so that an input/output device of the TV monitor 120 can operate as that of the computer 101. If the PC mode is chosen ,therefore, the user can confirm an image signal output from the computer 101 on the display device 127 of the TV monitor 120. If the PC mode is chosen, on the other hand, the user can control the computer 101 by using the keyboard 142 and the mouse 143, which are input/output devices of the TV monitor 120. If, in particular, the computer is located far away from the TV monitor, the computer can be remote-controlled using the keyboard 142 and the mouse 143, which are input/output devices of the TV monitor.

The invention may be embodied in other specific forms without departing from essential characteristics thereof.

This embodiment has been described with reference to an example where the computer 101 and the TV monitor 120 are connected to a home network via a high-speed serial interface in accordance with the IEEE1394-1995 Standards and arranged in the same building, but the present invention is not limited to this example.

Therefore, the above-mentioned embodiments are merely examples in all respects, and must not be construed to limit the invention.

The scope of the present invention is defined by the scope of the appended claims, and is not limited at all by the specific descriptions of this specification. Furthermore, all the modifications and changes belonging to equivalents of the claims are considered to fall within the scope of the present invention.

What is claimed is:

1. A display apparatus, comprising:
display means;
connecting means for connecting the display apparatus and an external apparatus; and
control means for controlling said display means so as to operate as a monitor of the external apparatus when a first mode is chosen, and controlling said display means so as to operate as a monitor of the external apparatus when a second mode is chosen.

2. The display apparatus according to claim 1, wherein when the first mode is chosen, the connecting means disconnects the display apparatus and the external apparatus.
